(19) United States
(12) Patent Application Publication
(10) Pub. No.: US 2015/0278138 A1
(43) Pub. Date: Oct. 1, 2015

(54) PSEUDORANDOM SEQUENCE SYNCHRONIZATION

(71) Applicants: Mark N. Seidel, Florence, AZ (US); Nguyen D. Vo, Gilbert, AZ (US)

(72) Inventors: Mark N. Seidel, Florence, AZ (US); Nguyen D. Vo, Gilbert, AZ (US)

(21) Appl. No.: 14/229,059

(22) Filed: Mar. 28, 2014

(51) Int. Cl. G06F 13/40; G06F 11/07

(52) U.S. Cl. CPC G06F 13/405; G06F 11/0763; G06F 11/0745

(57) ABSTRACT

A pseudorandom signal is received and used to train a link. Inversions of the pseudorandom signal are included and detected to identify a transition from link training data to a characterization data. The characterization data can be used to test or otherwise assess the link.

### FIELD

This disclosure pertains to computing systems, and in particular (but not exclusively) to interconnect architectures.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (i.e. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

Interconnects have grown from more traditional multi-drop buses that primarily handled electrical communications to full-blown interconnect architectures that facilitate fast communication. Unfortunately, as the demand for future processors to consume at even higher-rates increases, corresponding demand is placed on the capabilities of existing interconnect architectures.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates embodiments of potential high performance interconnect (HPI) system configurations.

FIG. 6 illustrates an embodiment of devices configured to signal transitions between link training data and characterization data through an inversion of the link training data.

FIG. 7 illustrates an embodiment of logic for generating pseudorandom link training data and inverted versions of the link training data.

FIG. 8 illustrates a representation of controlled inversion of a pseudorandom signal.

FIG. 9A illustrates an embodiment of pseudorandom binary sequence (PRBS) generation logic.

FIG. 9B illustrates an embodiment of pseudorandom binary sequence (PRBS) checker logic.

FIG. 10A illustrates an embodiment of logic for identifying a transition between link training data and characterization data from controlled inversion of the link training data.

FIG. 10B illustrates an embodiment of a filtered bit error sequence.

FIGS. 11A-11B illustrate examples of logic for identifying a transition between link training data and characterization data from controlled inversion of the link training data.

FIGS. 12A-12B are flowcharts illustrating example techniques associated with synchronizing pseudorandom sequences.

FIG. 13 illustrates an embodiment of a block diagram for a computing system including a multicore processor.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation, etc. in order to provide a thorough understanding of the subject matter of the present Specification. It will be apparent, however, to one skilled in the art that these specific details need not be employed to practice the methods, apparatus, articles, and systems, etc. described in the present Specification. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the discussion of the subject matter of the present Specification.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. While some specific examples of interconnect architectures are named and discussed below, it should be appreciated that the principles described in this Specification can potentially be applied to a number of other, unnamed, and yet to be formalized interconnect architectures, which would potentially also benefit from aspects of the subject matter described herein.

Examples of interconnect fabric architectures include the Peripheral Component Interconnect (PCI), Peripheral Component Interconnect (PCI) Express (PCIe), Quick Path Interconnect (QPI), High Performance Interconnect (HPI) (e.g., a serial point-to-point differential protocol with embedded clock), and Advanced Microcontroller Bus Architecture (AMBA) AXI architectures, among other examples. A primary goal of at least some interconnect architectures, such as load-store I/O architectures such as PCIe, is to enable components and devices from different vendors to inter-operate in an open architecture, spanning multiple market segments; Clients (Desktops and Mobile), Servers (Standard and Enterprise), and Embedded and Communication devices. As an example, PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

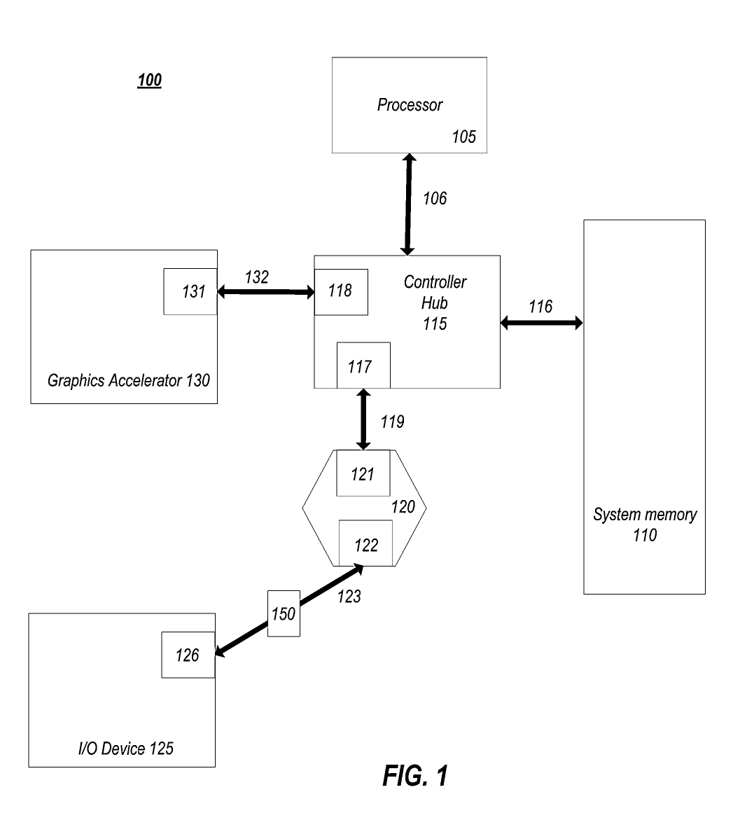

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in an interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual bridge devices, such as PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105.

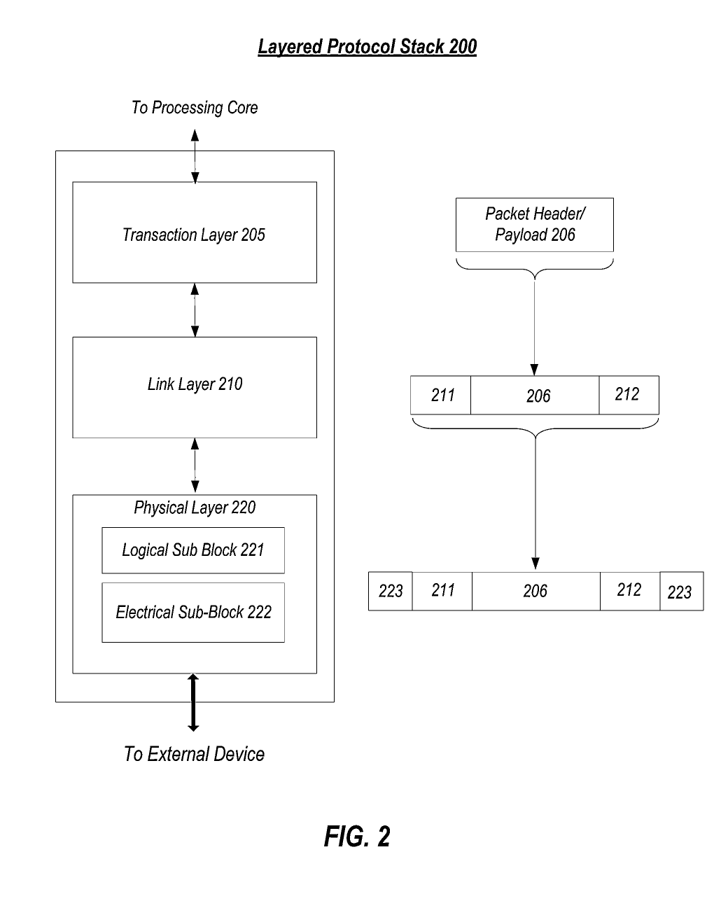

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. Split transactions can also be implemented, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space, for instance, of the PCIe devices. Transactions to the configuration space include read requests and write requests. Message space transactions (or, simply messages) are defined to support in-band communication between agents, such as PCIe agents.

Therefore, in one embodiment, transaction layer 205 assembles packet header/payload 206. Format for current packet headers/payloads of PCIe may be found in the PCIe specification at the PCIe specification website.

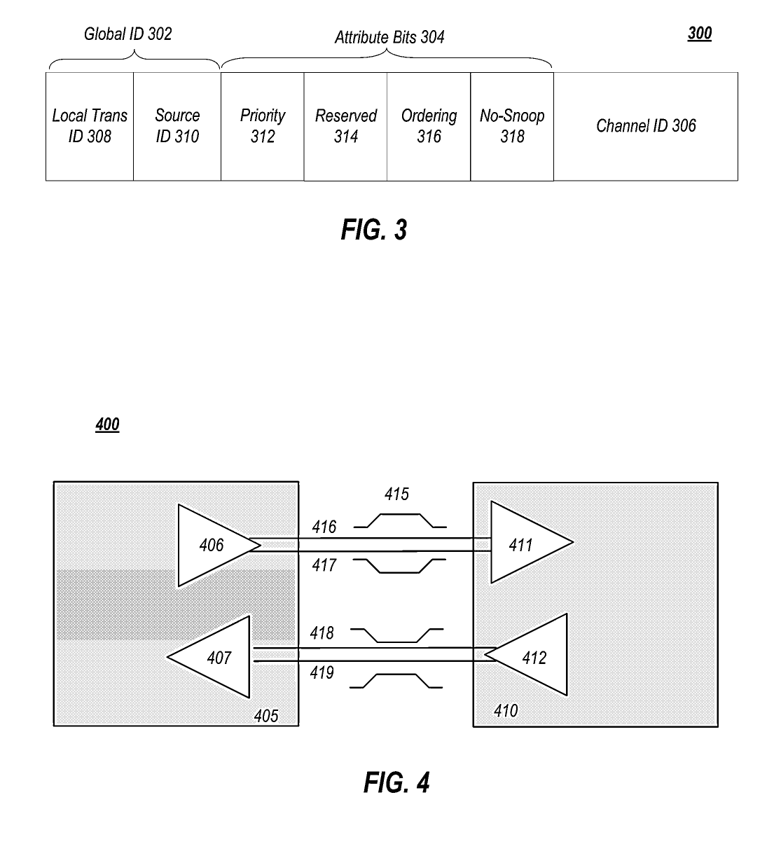

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

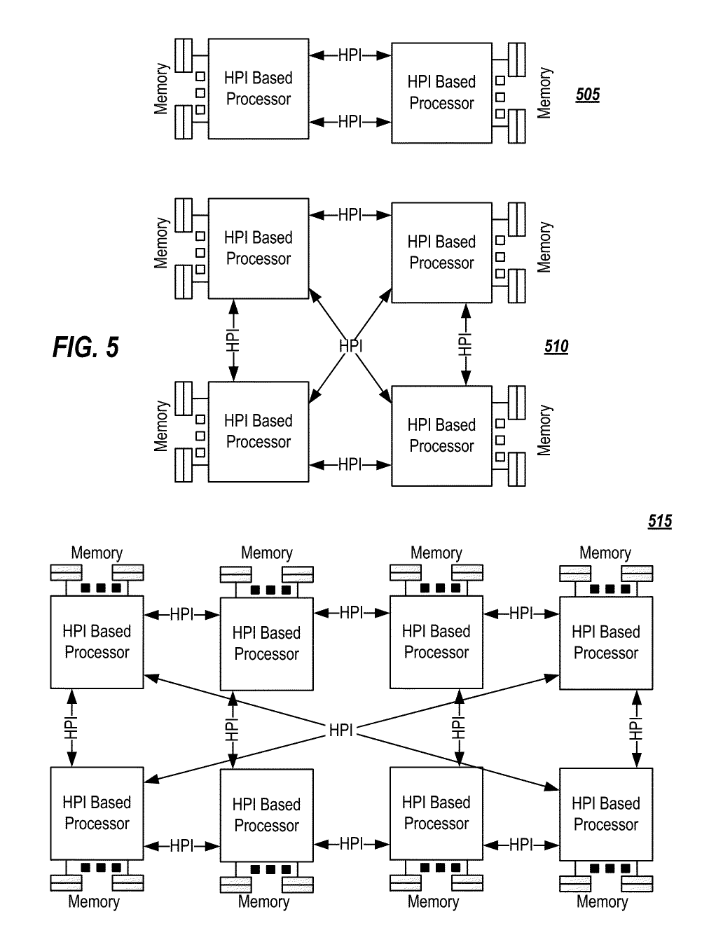

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/411 and a receive pair 412/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane —each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

In one embodiment, a new High Performance Interconnect (HPI) is provided. HPI can include a next-generation cache-coherent, link-based interconnect. As one example, HPI may be utilized in high performance computing platforms, such as workstations or servers, including in systems where PCIe or another interconnect protocol is typically used to connect processors, accelerators, I/O devices, and the like. However, HPI is not so limited. Instead, HPI may be utilized in any of the systems or platforms described herein. Furthermore, the individual ideas developed may be applied to other interconnects and platforms, such as PCIe, MIPI, QPI, etc.

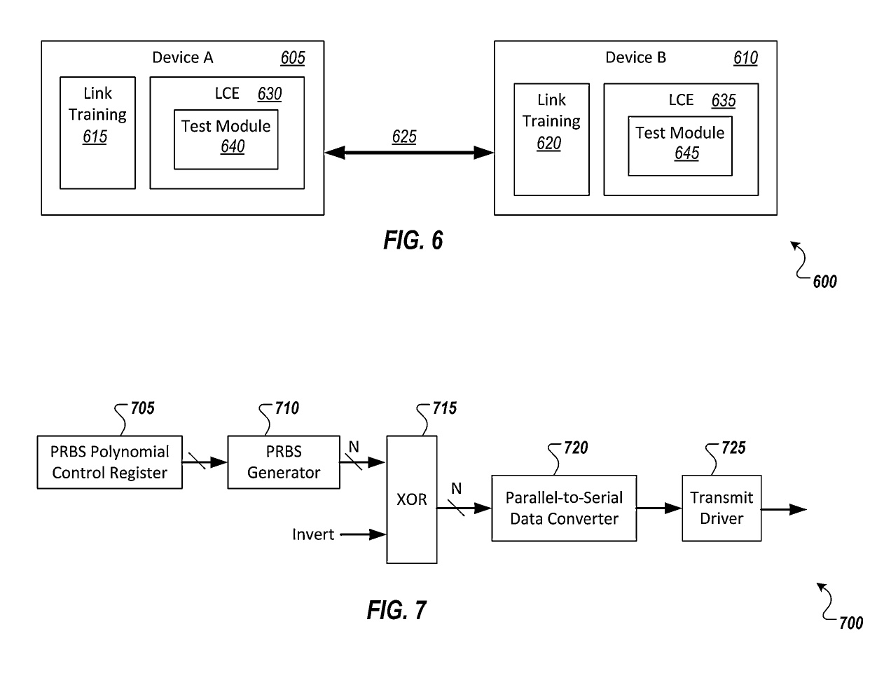

To support multiple devices, in one example implementation, HPI can include an Instruction Set Architecture (ISA) agnostic (i.e. HPI is able to be implemented in multiple different devices). In another scenario, HPI may also be utilized to connect high performance I/O devices, not just processors or accelerators. For example, a high performance PCIe device may be coupled to HPI through an appropriate translation bridge (i.e. HPI to PCIe). Moreover, the HPI links may be utilized by many HPI based devices, such as processors, in various ways (e.g. stars, rings, meshes, etc.). FIG. 5 illustrates example implementations of multiple potential multi-socket configurations. A two-socket configuration 505, as depicted, can include two HPI links; however, in other implementations, one HPI link may be utilized. For larger topologies, any configuration may be utilized as long as an identifier (ID) is assignable and there is some form of virtual path, among other additional or substitute features. As shown, in one example, a four socket configuration 510 has an HPI link from each processor to another. But in the eight socket implementation shown in configuration 515, not every socket is directly connected to each other through an HPI link. However, if a virtual path or channel exists between the processors, the configuration is supported. A range of supported processors includes 2-32 in a native domain. Higher numbers of processors may be reached through use of multiple domains or other interconnects between node controllers, among other examples.

In some implementations, test modes, or other modes, can be defined or enabled to allow for testing or assessment of a link. Test modes can include defined loopback modes, among other examples. Bit error rates of transmitter, receiver, and the up and downstream portions of the link connecting the transmitter and receiver can be determined through the assessment of the link. Traditionally, before testing of a link can commence, the link may first be trained. Depending on the protocol(s) employed on the link, various link training data can be sent. For example, random or pseudorandom bit sequences can be sent on the link to train the link in preparation for testing. Following the link training, a transition code or sequence can be sent to indicate that link training is ending and that testing is set to begin. This sequence can be particularly useful when the data to be sent during training (referred to interchangably herein as “link characterization data,” “characterization data,” “characterization signal”, and “test data”) is random or pseudorandom in nature, or is otherwise capable of being confused for link training data.

In some systems, pre-defined special characters, or bit sequences, can be sent as transition data to indicate the transition between link training data and characterization data. However, shortcomings exist in the use of such traditional transition data. For example, the transition data can be a predefined digital sequence. However, this digital sequence can potentially be within the data pattern of the link training data or characterization data, making some forms of the link training data and characterization data incompatible with the transition data (lest the appearance of the sequence within the link training data or characterization data be falsely mistaken for an instance of the transition data). Some transition data can be designed to avoid this, for instance, by defining a repeating special character or bit sequence, or a special character or bit sequence with a relatively long length (that is less likely to appear in link training data sequence). However, long or repeating special characters or bit sequences can disrupt the bit-pattern frequency and statistical properties of the link, as well as potentially line up with the transition data being in the link training data pattern at the wrong time, thus causing a false start (and millions of false bit “errors”), among other potential issues.

The logic, systems, and principles discussed herein can be used to resolve these and other example issues with traditional solutions. Further, solutions described herein can be used to provide robust and flexible transition schemes between link training and testing. Flexibility can be valuable because testing environments cannot always be accurately simulated ahead of time, especially for high data-rate systems. Robustness in comparison starting can also be useful because the patterns under consideration for testing can be the same or different from patterns that are used for training the receiver. An improved transition scheme can be provided that can flexibly support a variety of different link training and characterization data sequences, among other potential advantages.

In one example, the start of the testing data pattern (the characterization data) is signaled by inverting and un-inverting the link training sequence (such as a pseudo random bit sequence (PRBS)) in some fixed pattern. This pattern of inversions is easily detected in the receiver, and simple filtering can additionally be used to produce a signal that can be used as an oscilloscope trigger as well as a trigger for the data pattern comparison. Once the receiver detects the special pattern of inversions, a local compare engine (LCE) or other logic module can be designed to start the bit error rate (BER) or other testing at precisely the correct point without the use of transition data sequences or special characteristics in the link training sequence predefined to indicate a transition.

Designating transitions from link training data to characterization data through an inversion of the link training data can obviate the need for transition data that would otherwise have to be appended to link training data (such as embedded in longer PRBS sequences). A system can be configured to provide such inversion transitions while reusing much of the existing register transfer language (RTL) code, and simplifying it by eliminating the need for transition data and their register storage. Further, all PRBS sequences can be treated uniformly, providing for more reliable RTL generation and validation, and more flexibility in PRBS generating polynomials.

In some instances, a pattern of PRBS sequence inversions is employed in order to signal the start of characterization data, such as a loop-back data pattern comparison after sufficient time has occurred for receiver training This inversion can happen anywhere in the PRBS sequence, and programmability of the inversion pattern, along with a short time of bit comparison and fine-tuning of the comparison position, can provide for robust comparison starting. The characterization pattern that then undergoes comparison can be any pattern desired including clock-like, PRBS, industry-standard compliant patterns, and repeating special patterns, among other potential examples.

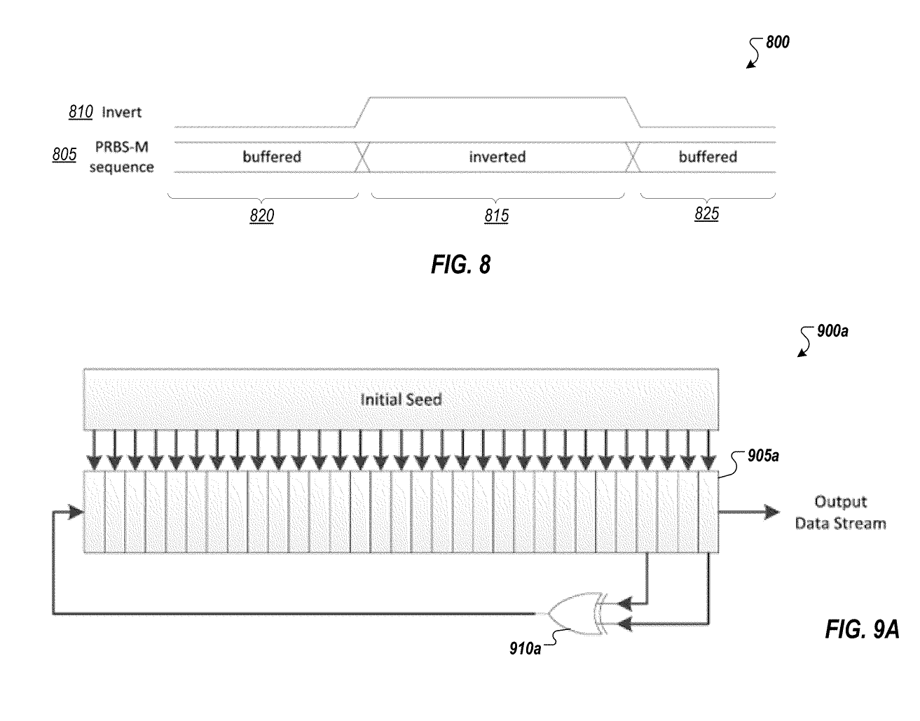

FIG. 6 is a simplified block diagram 600 illustrating devices 605, 610 within an example system, and further including a local compare engine. Devices 605, 610 can include components within a single computing device such as a personal computer, tablet, smartphone, or server system. In other instances, a first device 605 within a first endpoint can be connected to a second peripheral device (e.g., 610) outside the first endpoint, among other potential use cases and implementations. Regardless of the implementation, devices 605, 610 can each include link training logic modules (e.g., 615, 620) implemented through hardware, firmware, and/or software to implement link training of a link 625 communicatively coupling devices 605, 610. Devices 605, 610 can further include local compare engine modules 630, 635 that can be used to generate and/or detect transition signals implemented as an inverting and un-inverting of the link training sequence according to a predefined pattern. Upon detection of the transition, test logic modules 640, 645 can be used to perform a test of the performance of the link 625 (or one or both of devices 605, 610) using characterization data sent (and potentially looped back) following the transition sequence.

While FIG. 6 illustrates one example implementation of a local compare engine, it should be appreciated that alternate configurations can also be implemented without departing from the scope of the present discussion. For instance, in some implementations test module logic may be separate from the local compare engine. In other instances, link training logic may be included with local compare engine logic. In still other examples, rather than having portions of local compare engine on each of the transmitting and receiving endpoints (e.g., 605, 610), a local compare engine can be implemented as a block separate from one or more of the endpoints that controls and observes both the transmitter and receiver within the testing and/or link training modes, among other potential examples and implementations.

In some implementations, link 625 can be compliant with one or more interconnect architectures and protocols, such as Common System Interface (CSI), QPI, HPI, PCIe, or other examples. Further, in some cases, the link can include multiple data lanes operating together (whereon link training and testing can be performed). Device 605, 610 can employ digital techniques designed to operate at a total digital transfer rate exceeding 50 Gbit/s over the link 625 (this includes electrical, optical, or wireless). Link 625 can further be used in connection with telecommunication switching equipment. The total digital transfer rate is the unidirectional speed of a single interface, measured at the highest speed port or line, as well as equipment specially designed for aggregating the performance of digital computers by providing external interconnections which allow communications at unidirectional data rates exceeding 2.0 Gbyte/s per link, among other examples.

In some implementations, local compare engine (LCE) (e.g., 630, 635) logic can be configured to control a transmitter device to send out serial data that is used to train the receiver device on the link. The LCE can wait for a specific (and programmable) length of time or wait for the receiver to indicate that it has trained its timing and equalization loops, indicating that link training is completed. The LCE can further control the transmitter to send out serial transition data that is used to indicate the start of the characterization serial data (i.e., the serial data that is used to measure the bit-error rate (BER) of the receiver) and then cause the transmitter to send the characterization data. In some implementations, the LCE can support the use of transition data implemented as predefined special characters or bit sequences as well as transition data implemented to include inverted link training data. The LCE counts the number of bits of serial characterization data sent by the transmitter and compares the characterization data sent by the transmitter with the regular data received by the receiver (e.g., as reported through loopback data). The LCE can detect and count the number of errors in the received data (i.e., the number of bit-value differences between the transmitted bits and the received bits) and produce output values that allow for reading the number of bits sent and the number of errors in the received bit stream. In addition to this functionality, in some implementations, the LCE can also calculate the bit error rate (BER) of the link and/or control the transmitter and receiver by causing one or both devices to stop after a specific (and programmable) number of transmitted bits, among other example functionality.

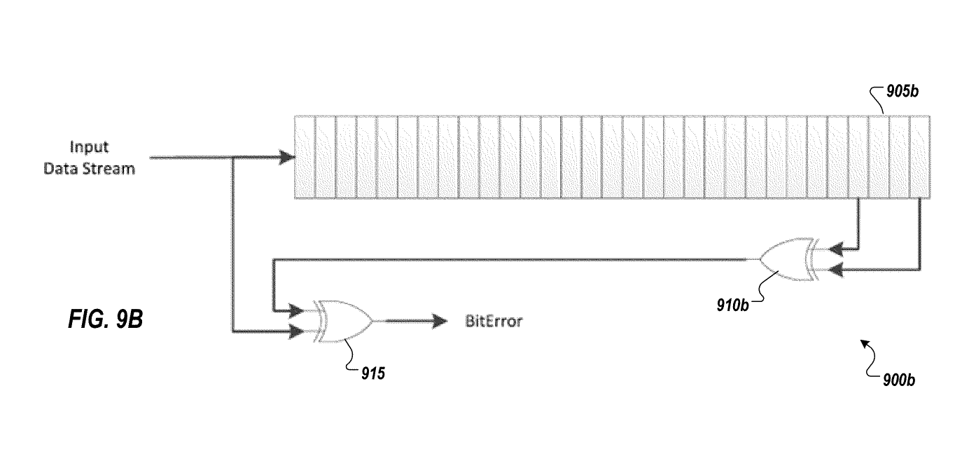

Turning to FIG. 7, a simplified block diagram 700 is shown illustrating logic that can be implemented in hardware, firmware, and/or software to generate un-inverted (i.e., buffered) and inverted link training data, such as PRBS sequences. In this example, a PRBS polynomial control register 705 provides seed data that is used by a PRBS generator 710 to generate a PRBS signal based on the seed. The PRBS signal can be used to train a link connecting two devices. Indeed, in some instances, the same PRBS signal can also be optionally used as characterization data for testing on the link. The PRBS data can proceed as intended for use in training the link. When link training is determined to be completed, an Invert signal can be asserted to invert the PRBS signal to indicate the transition. The PRBS signal can be inverted for a defined period (e.g., for a number of unit intervals (UIs)) or according to a particular pattern (e.g., a pattern of inverted and un-inverted PRBS sequences), such that the inverted PRBS sequence is identified by the receiver as a transition signal (i.e., and not legitimate link errors). As further shown in FIG. 7, PRBS signal logic can further include a parallel-to-serial data converter 720 as well as a transmit driver 725, among other potential components.

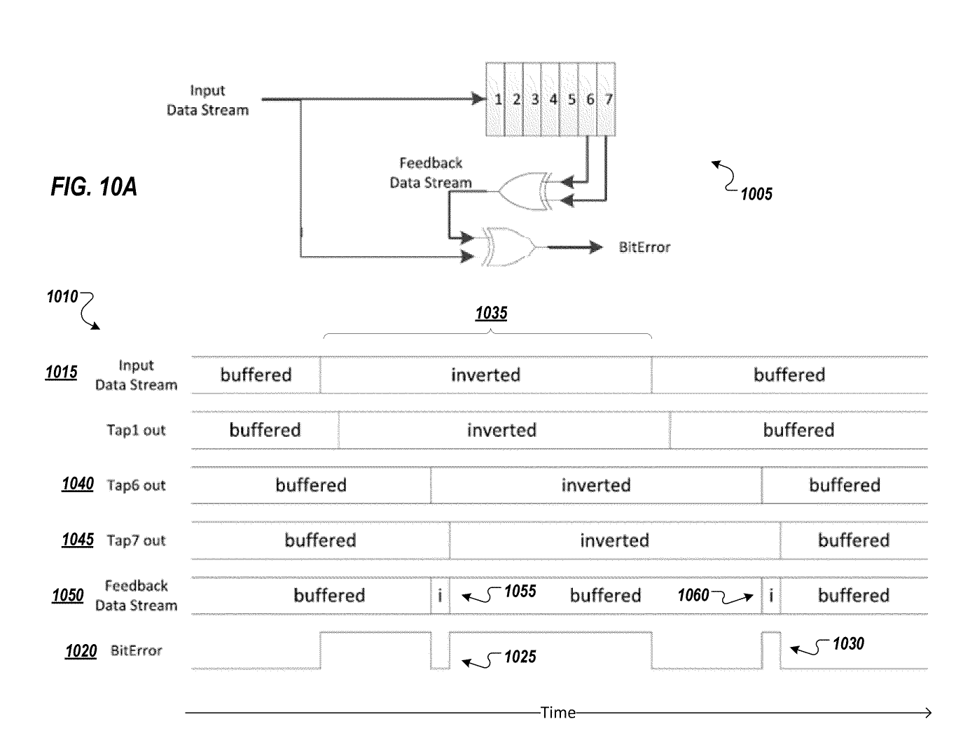

FIG. 8 is a simplified illustration 800 of an inverted/buffered PRBS-M sequence 805 (where M is the length of the seed state of the pseudo random number generator and can be M=7, 9, 15, 23, 31, etc.) generated, for instance, using logic such as shown and described in connection with FIG. 7. In this example, asserting the Invert signal 810 inverts the data path resulting in an inverted PRBS sequence 815. When the Invert signal 810 is low the data path is buffered and the PRBS is sent un-inverted (e.g., at 820, 825). By inverting the data signal in this way, the inversions can be realized on N-bit boundaries, thus making for easier alignment detection by a received device. The Invert signal 810 can be asserted/de-asserted (e.g., as pulses) for several UIs (e.g., potentially thousands of UIs) according to a predefined length or pattern defined for transition data in the system.

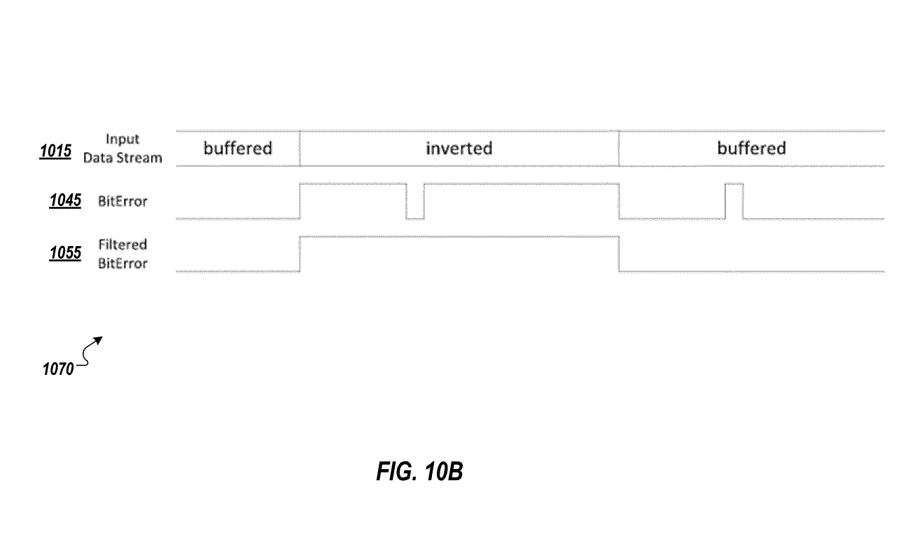

Turning to FIG. 9A, a simplified block diagram 900a is shown illustrating at least a portion of logic utilized in some examples to implement a PRBS generator. For example, a PRBS seed can be input to a 31-bit shift register 905a. In some implementations, a PRBS-31 signal is generated by feeding back the XOR of bits 31 and 28 of the register 905a (using XOR logic 910a) into the input, as shown in the diagram 900a. In some implementations, the PRBS-M bit stream can be detected using the same or similar structure that generates it. For instance, FIG. 9B illustrates a simplified block diagram 900b representing at least a portion of checker (or detection) logic configured to detect a PRBS stream and determine whether the PRBS stream matches the expected PRBS stream (i.e., as should be generated by a pre-defined PRBS seed).

Continuing with the example of FIG. 9B, checker logic can include a 32-bit shift register 905b and XOR logic 910b. Additionally, checker logic can include further XOR logic 915 to detect as bit errors deviations from the expected non-inverted PRBS sequence. For the checker structure, the feedback becomes the comparison; if the next incoming bit does not match the feedback bit, then there is an incoming bit error (indicated by the BitError signal). In some implementations, the incoming and outgoing streams are usually accomplished as parallel buses of 8, 10, 16, 20, 32, or 40 bits, with the bus width being dictated by the data rate and other system architectural considerations.

When checking an incoming PRBS stream for deviations from the expected un-inverted PBRS signal, as long as the input stream matches the feedback stream, the BitError signal generated by XOR logic 915 remains low. When the input data stream is inverted, and this inversion has existed for long enough that the entire shift register is populated with the inverted data stream, the feedback stream would be the same as if the buffered data stream was populating the shift register. In such a case, the BitError signal would be asserted and remain high for a duration. This condition of the feedback stream matching the buffered data stream, whether the input data stream is buffered or inverted, is true for any PRBS sequence that has an even number of feedback taps. Such is also true for maximum-length PRBS sequences. Examples include PRBS-7 (2 taps: taps 6 and 7), PRBS-23 (2 taps: taps 18 and 23), PCIe PRBS-23 (6 taps: taps 2, 7, 15, 18, 21, 23), PRBS-31 (2 taps: taps 28 and 31), PRBS-9, PRBS-15, etc. In addition, it also works for XNOR-generated sequences as well as XOR-generated sequences, among other examples.

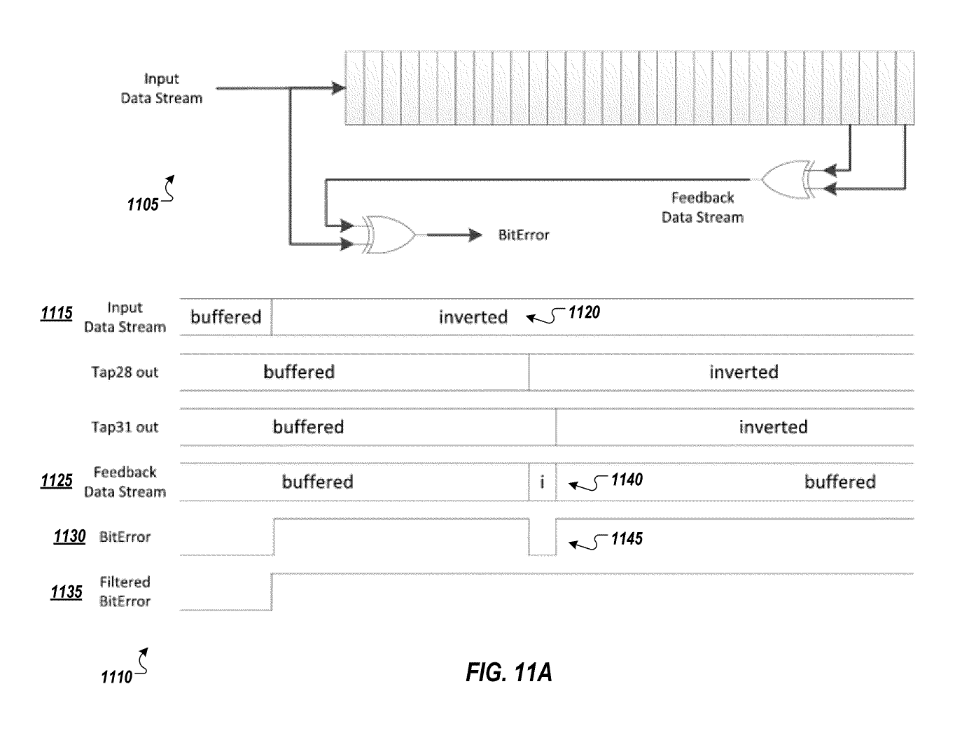

The transitions between buffered and inverted data streams depend on the particular PRBS sequence, but the particular point in the sequence does not affect the signature of the transitions (as identified in the corresponding BitError signal); that signature depends upon the tap placement and the length of the shift register. As an example illustration, FIG. 10A represents an implementation of checker logic 1005 configured to interpret a PRBS-7 signal according to at least some of the principles introduced above. Feedback taps are provided at bits 6 and 7 of the register of checker logic 1005. As illustrated in diagram 1010, the buffered and inverted input data streams are delayed as they go through the taps. When the feedback taps (taps 6 and 7)are both buffered or both inverted, then the feedback data stream matches the buffered data stream. When, however, the feedback taps are different, then the feedback data stream is inverted. The final XOR compares the input and feedback data streams; when they are both buffered or both inverted, then the BitError signal is low, and when they are different, then the BitError signal is high. Therefore, the BitError signal is an indication of when the incoming data stream inverts and when it is buffered. For instance, when the duration of this high BitError signal signature corresponds to what would be expected when the inverted signal is to indicate a transition, the BitError signal is interpreted to indicate a transition signal from link training to characterization. On the other hand, BitErrors not in line with the expected signature of a transition signal can be identified as legitimate bit errors and handled accordingly.

As illustrated in diagram 1010, the bit error signal 1020 may not correspond exactly with the inversion of the input PRBS stream 1015. In some implementations, small pulses (e.g., 1025, 1030) can interrupt the bit error signal's correspondence with the inversion (e.g., 1035) of the input data stream 1015. These small pulses 1025, 1030 can happen shortly after the buffered/inverted transitions and result from asymmetry at the taps resulting from a delay in the inversion propagating across the register. This (temporary) mismatch between the tap signals (1040, 1045) manifests itself in feedback data stream 1050 as inversions (e.g., at 1055, 1060) resulting in the pulses 1025, 1030 in the bit error signal 1020.

In some implementations, the bit error signal signature that is mapped to the defined inversion signal can be defined to correspond to the bit error signal with pulses 1025, 1030 that manifests from a defined inverted PRBS transition signal 1030. In such instances, when a bit error signal is detected matching bit error signal 1020 with pulses 1025, 1030, the bit error signal can be interpreted to indicate a transition. In other cases, pulses 1025, 1030 can be filtered out of the bit error signal 1020 to produce a clean bit error signal pulse that corresponds precisely to the duration of the inversion 1035. For example, a mapping can be used that looks at the bit in question as well as the bit before and the bit after (corresponding to an expected pulse (e.g., 1025, 1030)). If the bit is the same as the bit before or after (or both) then the filtered output is the same as the bit. If, however, the bit is different from both the bit after and before, then the filtered output is the opposite of the bit. FIG. 10B illustrates a diagram 1070 showing a result of the filtering (at 1075) of bit error signal 1045. This filtered output 1075 corresponds precisely with the inversion 1035 and can be used to identify whether bit errors actually indicate a transition from link training to testing.

A bit error signal (e.g., 1020) or filtered bit error signal (e.g., 1075) can be used as the signaling method for an LCE or other logic module to indicate when the input data stream is buffered or inverted. Patterns in the timing of buffering and inverting of the input signal to indicate a transition can be defined to reduce the impact of noise in the system. Further, buffering and inverting of an input signal (such as a PRBS signal) can be arranged to be done only at the N-bit boundaries of the system, allowing for easier alignment and comparison of the received data stream. Accordingly, in some implementations, the receiver can be trained on the same PRBS data sequence as will be used to characterize its performance, with no additional special characters or bit sequences needed for signaling transitions (e.g., as such transition data may potentially masquerade in the link training data sequence or change the statistics of the link training data pattern). Alternatively, the receiver can be trained on one PRBS sequence and characterized using a different sequence (either PRBS or something else such as a clock pattern, industry-standard compliant jitter pattern, or a repeating fixed pattern, among other examples).

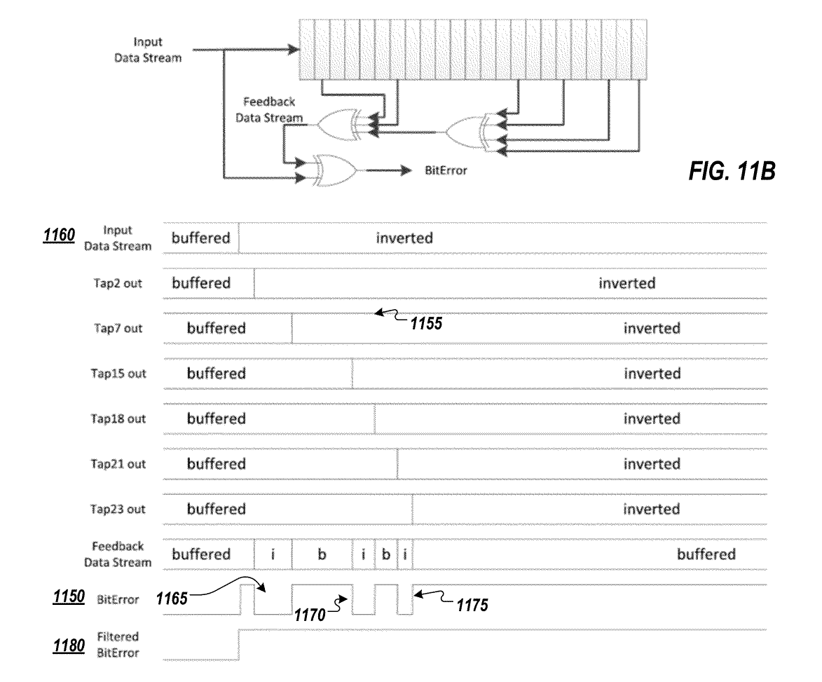

FIGS. 11A and 11B illustrate potential embodiments of logic for indicating a transition between link training data and characterization data through inverting the link. For instance, FIG. 11A represents an embodiment employing PRBS-31 as link training data (e.g., input data 1115) that is to be monitored both for legitimate bit errors, as well as bit error patterns (e.g., inversion 1120) that correspond to a signature mapped to a defined transition signal for transitioning between the link training data and characterization data. The example of FIG. 11A includes two feedback taps (at bits 28 and 31) and results in a bit error signal 1130 that goes high to correspond with the inversion (1120) of the input data stream (1115), with the exception of pulse 1145 corresponding to the momentary 3-bit wide inversion (at 1140) of feedback data stream 1125 resulting from the delay in the propagation of the inversion from bit 28 to 31 of the register (i.e., with the three-bit-width corresponding to the distance between the two feedback taps). The bit error signal 1130 possessing pulse 1145 can be filtered to remove the pulses and the filtered bit error signal 1135 can be provided to an LCE or other logic module for assessing transitions from the link training data.

Turning to FIG. 11B, a representation is shown of another example embodiment, in this case employing PRBS-23 as link training data that can be inverted to indicate a transition from link training data to characterization data. As shown in FIG. 11B, PRBS-23 (such as used in PCIe) employs six feedback taps at bits 2, 7, 15, 18, 21, and 23. The bit error sequence 1150 that is output in response to a defined inversion 1155 of input data stream 1160 is even less “pulse-like”, with multiple grooves, or small pulses, (e.g., 1165, 1170, 1175) manifesting from the delays between the multiple forward taps. Notwithstanding the more complicated bit error stream signature (with pulses 1165, 1170, 1175), this signature can also be detected and filtered (e.g., to produce filtered bit error signal 1180).

While some of the examples described above describe implementing a transition signal as a single inversion of a link training sequence (e.g., PRBS) signal for a particular duration, in other cases a defined pattern of inverted and un-inverted (“buffered”) link training sequences can be defined as a transition signal. Indeed, in some cases, such as that illustrated in the example of FIG. 11B, several buffered-inverted-buffered transitions at regular-spaced intervals can be provided to assist in dealing with the issue of determining the precise transition locations in time. This precision is important so that true bit errors can also be discovered and the BER calculated properly. Alternatively, there can be a period and process of adjustment and fine calibration to get the LCE on or very close to the transition points. Toggling inversion of the link training sequence according to a pattern can also increase (relative to a single inversion) the probability of correctly determining the precise location of the transition data. Even where the location of the transition data can only be closely approximated, this still allows for the search space to be vastly reduced. Generally, such solutions can provide the robustness that leads to the flexibility of characterizing the receiver on the same, similar, or different statistically-characterized data sets on which they are trained.

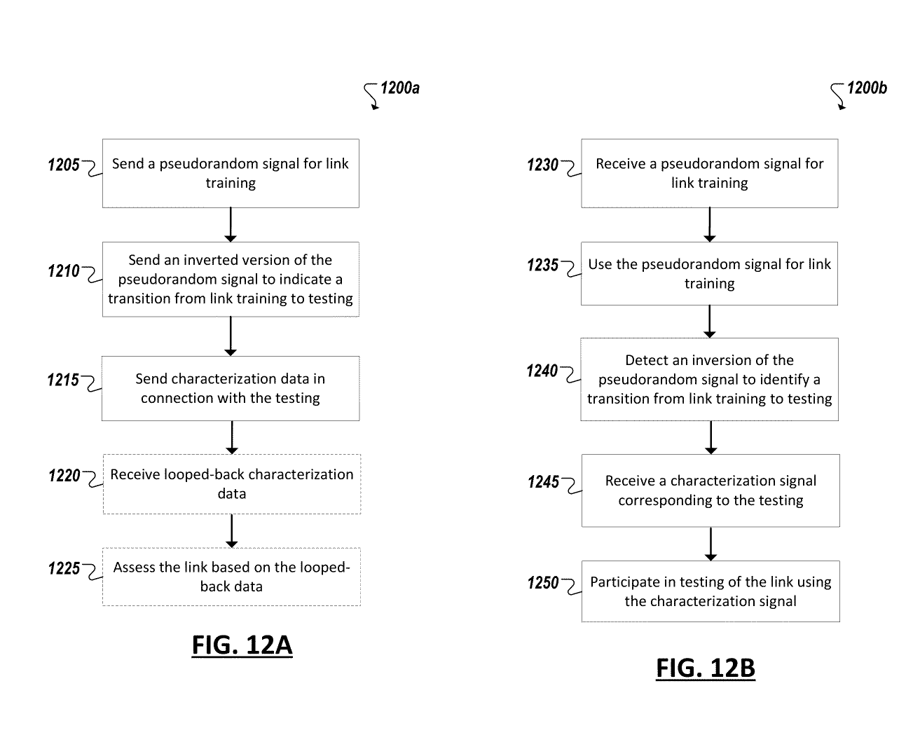

FIGS. 12A-12B are flowcharts 1200a-b illustrating example techniques associated with synchronizing pseudorandom sequences, with flowchart 1200a associated with the transmit end of the link of an interconnect and flowchart 1200b associated with the receive end of the link of an interconnect. For instance, in FIG. 12A, a pseudorandom signal is sent 1205 from a first device to a second device using a link of an interconnect. The pseudorandom signal is for use in training the link connecting the devices. An inverted version of the pseudorandom signal is generated and sent 1210 to indicate a transition of data for use in link training to data for use in testing of the link. Characterization (or testing) data is sent 1215 following the inverted version of the pseudorandom signal for use in testing the link. In some instances, testing can be conducted in a loopback mode, where the characterization data is to be looped-back (at 1220) for use in assessing 1225 the link (e.g., determining a bit error rate for the link), among other examples.

Turning to FIG. 12B, a pseudorandom signal is received 1230 from another device over a link to train 1235 the link. An inversion of the pseudorandom signal can be detected 1240 and interpreted as a transition signal indicating a transition from link training data to testing (or characterization) data. The characterization data can be received 1245 and the receiving device can participate 1250 in testing using the received characterization data 1250. In some implementations, a test mode can be entered to assess the link. In some cases, a loopback mode can be provided for the testing and the received characterization can be looped back to be assessed at the transmitter. In some instances, the link can be assessed at the receiver. The receiver, for example, can have a copy of the data pattern generator that is started when the receiver knows that the characterization pattern is starting allowing the receiver to detect errors as they arrive. Other examples and protocols can also be supported and use the characterization data in connection with testing of the link.

Note that the apparatus', methods', and systems described above may be implemented in any electronic device or system as aforementioned. As specific illustrations, the figures below provide exemplary systems for utilizing the principles described herein. As the systems below are described in more detail, a number of different interconnects are disclosed, described, and revisited from the discussion above. And as is readily apparent, the advances described above may be applied to any of those interconnects, fabrics, or architectures.

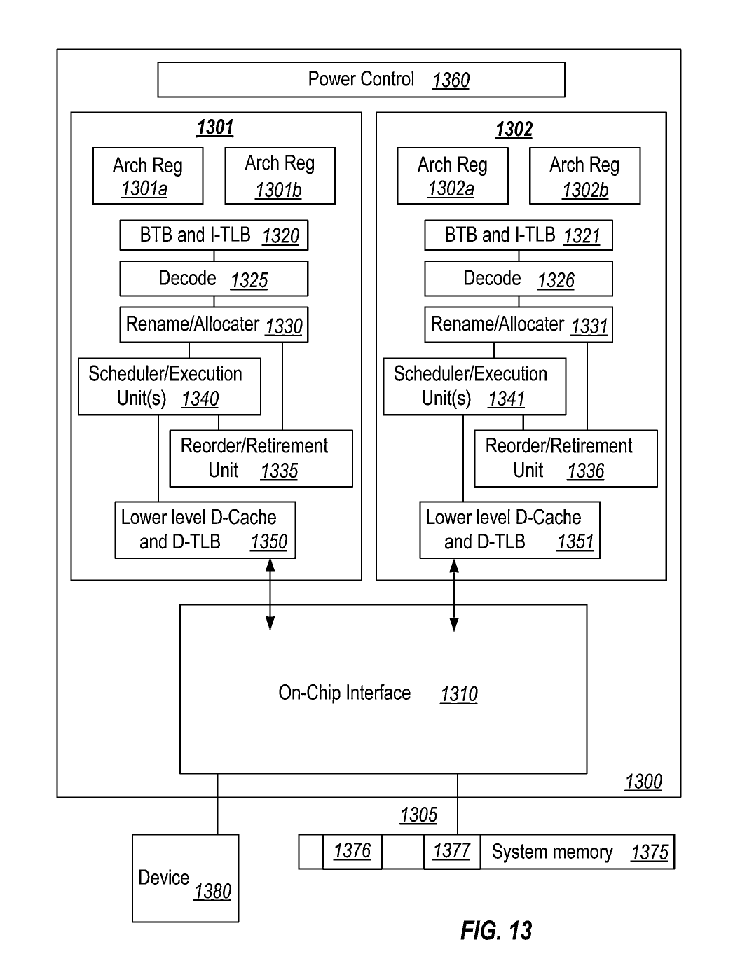

Referring now to FIG. 13, an embodiment of a block diagram for a computing system including a multicore processor is depicted. Processor 1300 includes any processor or processing device, such as a microprocessor, an embedded processor, a digital signal processor (DSP), a network processor, a handheld processor, an application processor, a co-processor, a system on a chip (SOC), or other device to execute code. Processor 1300, in one embodiment, includes at least two cores—core 1301 and 1302, which may include asymmetric cores or symmetric cores (the illustrated embodiment). However, processor 1300 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1300, as illustrated in FIG. 13, includes two cores—core 1301 and 1302. Here, core 1301 and 1302 are considered symmetric cores, i.e. cores with the same configurations, functional units, and/or logic. In another embodiment, core 1301 includes an out-of-order processor core, while core 1302 includes an in-order processor core. However, cores 1301 and 1302 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1301 are described in further detail below, as the units in core 1302 operate in a similar manner in the depicted embodiment.

As depicted, core 1301 includes two hardware threads 1301a and 1301b, which may also be referred to as hardware thread slots 1301a and 1301b. Therefore, software entities, such as an operating system, in one embodiment potentially view processor 1300 as four separate processors, i.e., four logical processors or processing elements capable of executing four software threads concurrently. As alluded to above, a first thread is associated with architecture state registers 1301a, a second thread is associated with architecture state registers 1301b, a third thread may be associated with architecture state registers 1302a, and a fourth thread may be associated with architecture state registers 1302b. Here, each of the architecture state registers (1301a, 1301b, 1302a, and 1302b) may be referred to as processing elements, thread slots, or thread units, as described above. As illustrated, architecture state registers 1301a are replicated in architecture state registers 1301b, so individual architecture states/contexts are capable of being stored for logical processor 1301a and logical processor 1301b. In core 1301, other smaller resources, such as instruction pointers and renaming logic in allocator and renamer block 1330 may also be replicated for threads 1301a and 1301b. Some resources, such as re-order buffers in reorder/retirement unit 1335, ILTB 1320, load/store buffers, and queues may be shared through partitioning. Other resources, such as general purpose internal registers, page-table base register(s), low-level data-cache and data-TLB 1315, execution unit(s) 1340, and portions of out-of-order unit 1335 are potentially fully shared.

Processor 1300 often includes other resources, which may be fully shared, shared through partitioning, or dedicated by/to processing elements. In FIG. 13, an embodiment of a purely exemplary processor with illustrative logical units/resources of a processor is illustrated. Note that a processor may include, or omit, any of these functional units, as well as include any other known functional units, logic, or firmware not depicted. As illustrated, core 1301 includes a simplified, representative out-of-order (000) processor core. But an in-order processor may be utilized in different embodiments. The 000 core includes a branch target buffer 1320 to predict branches to be executed/taken and an instruction-translation buffer (I-TLB) 1320 to store address translation entries for instructions.

Core 1301 further includes decode module 1325 coupled to fetch unit 1320 to decode fetched elements. Fetch logic, in one embodiment, includes individual sequencers associated with thread slots 1301a, 1301b, respectively. Usually core 1301 is associated with a first ISA, which defines/specifies instructions executable on processor 1300. Often machine code instructions that are part of the first ISA include a portion of the instruction (referred to as an opcode), which references/specifies an instruction or operation to be performed. Decode logic 1325 includes circuitry that recognizes these instructions from their opcodes and passes the decoded instructions on in the pipeline for processing as defined by the first ISA. For example, as discussed in more detail below decoders 1325, in one embodiment, include logic designed or adapted to recognize specific instructions, such as transactional instruction. As a result of the recognition by decoders 1325, the architecture or core 1301 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1326, in one embodiment, recognize the same ISA (or a subset thereof). Alternatively, in a heterogeneous core environment, decoders 1326 recognize a second ISA (either a subset of the first ISA or a distinct ISA).

In one example, allocator and renamer block 1330 includes an allocator to reserve resources, such as register files to store instruction processing results. However, threads 1301a and 1301b are potentially capable of out-of-order execution, where allocator and renamer block 1330 also reserves other resources, such as reorder buffers to track instruction results. Unit 1330 may also include a register renamer to rename program/instruction reference registers to other registers internal to processor 1300. Reorder/retirement unit 1335 includes components, such as the reorder buffers mentioned above, load buffers, and store buffers, to support out-of-order execution and later in-order retirement of instructions executed out-of-order.

Scheduler and execution unit(s) block 1340, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1350 are coupled to execution unit(s) 1340. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1301 and 1302 share access to higher-level or further-out cache, such as a second level cache associated with on-chip interface 1310. Note that higher-level or further-out refers to cache levels increasing or getting further way from the execution unit(s). In one embodiment, higher-level cache is a last-level data cache—last cache in the memory hierarchy on processor 1300—such as a second or third level data cache. However, higher level cache is not so limited, as it may be associated with or include an instruction cache. A trace cache—a type of instruction cache—instead may be coupled after decoder 1325 to store recently decoded traces. Here, an instruction potentially refers to a macro-instruction (i.e. a general instruction recognized by the decoders), which may decode into a number of micro-instructions (micro-operations).

In the depicted configuration, processor 1300 also includes on-chip interface module 1310. Historically, a memory controller, which is described in more detail below, has been included in a computing system external to processor 1300. In this scenario, on-chip interface 131 is to communicate with devices external to processor 1300, such as system memory 1375, a chipset (often including a memory controller hub to connect to memory 1375 and an I/O controller hub to connect peripheral devices), a memory controller hub, a northbridge, or other integrated circuit. And in this scenario, bus 1305 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1375 may be dedicated to processor 1300 or shared with other devices in a system. Common examples of types of memory 1375 include DRAM, SRAM, non-volatile memory (NV memory), and other known storage devices. Note that device 1380 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1300. For example in one embodiment, a memory controller hub is on the same package and/or die with processor 1300. Here, a portion of the core (an on-core portion) 1310 includes one or more controller(s) for interfacing with other devices such as memory 1375 or a graphics device 1380. The configuration including an interconnect and controllers for interfacing with such devices is often referred to as an on-core (or un-core configuration). As an example, on-chip interface 1310 includes a ring interconnect for on-chip communication and a high-speed serial point-to-point link 1305 for off-chip communication. Yet, in the SOC environment, even more devices, such as the network interface, co-processors, memory 1375, graphics processor 1380, and any other known computer devices/interface may be integrated on a single die or integrated circuit to provide small form factor with high functionality and low power consumption.

In one embodiment, processor 1300 is capable of executing a compiler, optimization, and/or translator code 1377 to compile, translate, and/or optimize application code 1376 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

While the subject matter of the present Specification has been described with respect to a limited number of embodiments, those skilled in the art will appreciate numerous modifications and variations therefrom. It is intended that the appended claims cover all such modifications and variations as fall within the true spirit and scope of this Specification.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present Specification.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform some embodiments may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and a method to receive a pseudorandom signal, use the pseudorandom signal to train a link, and detect an inversion of the pseudorandom signal to identify a transition to a characterization data.

In at least one example, the characterization data is to be used to test the link.

In at least one example, the characterization data is received and looped-back to test the link.

In at least one example, a sequence of bit errors are generated based on the inversion and the inversion is detected based on the sequence of bit errors.

In at least one example, the inversion is detected based on the sequence of bit errors and the transition is identified based on a determination that the sequence of bit errors match a defined pattern.

In at least one example, the detection logic is further to filter the sequence of bit errors so that the sequence of bit errors corresponds to the inversion.

In at least one example, the sequence of bit errors is filtered to remove pulses from the sequence of bit errors.

In at least one example, a shift register and exclusive OR (XOR) logic are used to detect the inversion.

In at least one example, the pseudorandom signal includes at least one of a PRBS-7, PRBS-23, and PRBS-31 sequence.

In at least one example, the characterization data includes the pseudorandom signal.

In at least one example, the characterization data is different from the pseudorandom signal.

One or more embodiments may provide an apparatus, a system, a machine readable storage, a machine readable medium, and a method to send a pseudorandom signal from a first device to a second device, where the pseudorandom signal is to train a link and the link is to couple the first and second devices. An inverted version of the pseudorandom signal is sent on the link to indicate a transition from link training data to link characterization data, and the link characterization data is sent to test the link.

In at least one example, the pseudorandom signal is generated, for instance, using a shift register and exclusive OR (XOR) logic.

In at least one example, the pseudorandom signal includes a pre-defined sequence and inverting the pseudorandom signal causes values in the sequence to be inverted.

In at least one example, the inverted version of the pseudorandom signal includes a plurality of inversions of the pseudorandom signal according to a defined pattern.

In at least one example, looped-back characterization data is received and the link is assessed from the looped-back characterization data.

In at least one example, the characterization data includes a pseudorandom binary sequence (PRBS).

In at least one example, the pseudorandom signal includes the same pseudorandom binary sequence (PRBS).

In at least one example, a system is provided that includes a first hardware component and a second hardware component connected to the first hardware component by a link of an interconnect. The second hardware component can send a pseudorandom signal to the first hardware component, where the pseudorandom signal is for use in training the link. The second hardware component can further send an inverted version of the pseudorandom signal on the link to indicate a transition from link training data to link characterization data, and send, subsequent to the inverted version of the pseudorandom signal, the link characterization data for testing of the link.

In at least one example, the system can further include a local compare engine to control sending and inverting of the pseudorandom signal. At least one of the first and second hardware components can include a microprocessor.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the subject matter set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
receiving logic to receive a pseudorandom signal;
link training logic to use the pseudorandom signal to train a link;
detection logic to detect an inversion of the pseudorandom signal to identify a transition to a characterization data.

2. The apparatus of claim 1, wherein the characterization data is to be used to test the link.

3. The apparatus of claim 2, further comprising test logic to receive and loopback the characterization data to test the link.

4. The apparatus of claim 1, wherein a sequence of bit errors are generated based on the inversion and the inversion is detected based on the sequence of bit errors.

5. The apparatus of claim 4, wherein the inversion is detected based on the sequence of bit errors and the transition is identified based on a determination that the sequence of bit errors match a defined pattern.

6. The apparatus of claim 5, wherein the detection logic is further to filter the sequence of bit errors so that the sequence of bit errors corresponds to the inversion.

7. The apparatus of claim 6, wherein the sequence of bit errors is filtered to remove pulses from the sequence of bit errors.

8. The apparatus of claim 1, wherein the detection logic comprises a shift register and exclusive OR (XOR) logic.

9. The apparatus of claim 1, wherein the pseudorandom signal comprises at least one of a PRBS-7, PRBS-23, and PRBS-31 sequence.

10. The apparatus of claim 1, wherein the characterization data comprises the pseudorandom signal.

11. The apparatus of claim 1, wherein the characterization data is different from the pseudorandom signal.

12. An apparatus comprising:
logic, implemented at least in part in hardware, to:
send a pseudorandom signal from a first device to a second device, wherein the pseudorandom signal is to train a link and the link is to couple the first and second devices;
send an inverted version of the pseudorandom signal on the link to indicate a transition from link training data to link characterization data; and
send the link characterization data to test the link.

13. The apparatus of claim 12, wherein the logic is further to generate the pseudorandom signal.

14. The apparatus of claim 12, wherein the logic comprises a shift register and exclusive OR (XOR) logic.

15. The apparatus of claim 12, wherein the pseudorandom signal comprises a pre-defined sequence and inverting the pseudorandom signal causes values in the sequence to be inverted.

16. The apparatus of claim 12, wherein the inverted version of the pseudorandom signal comprises a plurality of inversions of the pseudorandom signal according to a defined pattern.

17. The apparatus of claim 12, wherein the logic is further to receive looped-back characterization data and assess the link from the looped-back characterization data.

18. The apparatus of claim 17, wherein the characterization data comprises a pseudorandom binary sequence (PRBS).

19. The apparatus of claim 18, wherein the pseudorandom signal comprises the same pseudorandom binary sequence (PRBS).

20. A method comprising:
receiving a pseudorandom signal;
using the pseudorandom signal to train a link;
detecting an inversion of the pseudorandom signal to identify a transition to a characterization data;
receiving the characterization data; and
participating in testing of the link using the characterization data.

21. A method comprising:
sending a pseudorandom signal from a first device to a second device, wherein the pseudorandom signal is to train a link and the link is to couple the first and second devices;
sending an inverted version of the pseudorandom signal on the link to indicate a transition from link training data to link characterization data; and
sending, subsequent to the inverted version of the pseudorandom signal, the link characterization data to test the link.

22. The method of claim 21, further comprising:
receiving loopback data, wherein the loopback data comprises a version of the link characterization data; and
testing the link based on the loopback data.

23. A system comprising:
a first hardware component;
a second hardware component connected to the first hardware component by a
link of an interconnect, wherein the second hardware component is to:
send a pseudorandom signal to the first hardware component, wherein the pseudorandom signal is for use in training the link;
send an inverted version of the pseudorandom signal on the link to indicate a transition from link training data to link characterization data; and
send, subsequent to the inverted version of the pseudorandom signal, the link characterization data for testing of the link.

24. The system of claim 23, further comprising a local compare engine to control sending and inverting of the pseudorandom signal.

25. The system of claim 23, wherein at least one of the first and second hardware components comprise a microprocessor.
